(19) United States
(12) Patent Application Publication
(10) Pub. No.: US 2021/0279526 A1
(43) Pub. Date: Sep. 9, 2021

(54) METHOD OF MODELLING FOR CHECKING THE RESULTS PROVIDED BY AN ARTIFICIAL NEURAL NETWORK AND OTHER ASSOCIATED METHODS

(71) Applicant: DREAMQUARK, PARIS (FR)

(72) Inventors: Benoît SCHMAUCH, PARIS (FR); Johan FERRET, PARIS (FR); Nicolas MERIC, PARIS (FR)

(21) Appl. No.: 17/255,824

(22) PCT Filed: Jun. 28, 2019
(86) PCT No.: PCT/EP2019/067289

§ 371 Date: Dec. 23, 2020

(30) Foreign Application Priority Data
Jun. 29, 2018 (FR) 1856012

(51) Int. Cl. G06K 9/62; G06N 3/08; G06N 3/04

(52) U.S. Cl. CPC G06K 9/6262; G06N 3/0454; G06N 3/08; G06K 9/6202

(57) ABSTRACT

A method of modelling for checking the results provided by an artificial neural network, includes generating an artificial neural network; training the artificial neural network on a training database; testing the artificial neural network on at least one test datum dependent on a plurality of variables vᵢ; so as to obtain a result R per test datum, the result R being dependent on the variables vᵢ; for each result R: approximating by a linear model a first function F₁ dependent solely on the result R so as to obtain a second function F₂, the first function F₁ and the second function F₂ being dependent on the variables vᵢ; simplifying the second function F₂ to obtain a third function F₃ dependent on a smaller number of variables vᵢ; applying to the third function F₃ the inverse function of the first function F₁ to obtain an operating model of the neural network.

### TECHNICAL FIELD OF THE INVENTION

The technical field of the invention is that of artificial neural networks. The present invention relates to a method making it possible to check the results provided by an artificial neural network and more particularly a method of modelling for checking the results provided by an artificial neural network. The present invention also relates to a method of checking the results provided by an artificial neural network, a method of comparing the performance of two artificial neural networks, a method of analysing a decision making by an artificial neural network, a device and a computer program product implementing such methods and a recording medium of the computer program product.

### TECHNOLOGICAL BACKGROUND OF THE INVENTION

Neural networks or artificial neural networks form the main tool for deep learning which attempts to model data in order to be able afterwards to carry out specific tasks with new data, such as classification or detection tasks. For this, a neural network passes through a training phase or learning phase during which it learns by passing over several iterations through a training database then by a generalisation phase during which it carries out, on a generalisation database, the task for which it was trained. A neural network is a complex algorithm, that entails several thousand—even millions of parameters in its decision making. Although this complexity is necessary in order for the neural network to have the capacity of detecting structures in data, it limits the interpretation that can be made of the results by a user, preventing the user from checking the pertinence thereof.

For example, in the case of detecting people in an image, an image is provided to the neural network as input and the neural network ideally provides as output the same image wherein it has framed the people. The neural network can provide as output the image wherein it has indeed framed all the people present—which will suggest to the user that the neural network is effective—without however the parameters that it used to detect the people all being pertinent. For example, if all the images that were supplied to the neural network during the learning thereof represent one person on a sky-blue background, the neural network could have chosen to base its result in particular on the colour of the background, not only on the characteristics specific to a person. The neural network then detects people on a blue background very well but will be unable to detect a person on a red background. In this precise case, the neural network is not suitable for the detection of people. However, the user could have concluded the contrary based on the results provided by the neural network on the images with a blue background.

In the field of image processing, there are visual tools that make it possible to display the zones of the image on the basis of which the neural network took its decision. However, these tools are not suitable for other types of data, such as audio recordings or biological data.

Another example would be the case where the user has two different neural networks that have similar performance on a test base and where the user wants to determine which one of the two neural networks used in its decision-making variables preferred by the user. The preferred variables are for example variables that are more easily interpreted. For example, in the case of the classification of animals into two classes, polar bear and grizzly bear, using data that comprises for example the colour of the fur, the type of food, the age of the animal, the size of the animal etc., a preferred variable of the user could be the colour of the fur since it is the most obvious difference between the two species. The two neural networks can both have the same performance and correctly classify the datum but the user will prefer to use in their application the first neural network which mainly uses the colour of the fur and of which the operation is therefore easier to apprehend than the second neural network that also uses the age of the animal and its size to conclude.

Thus, when a neural network is involved in a decision-making that can have serious consequences, for example the decision of whether or not to brake for an autonomous vehicle or the decision of whether or not to operate on an ill person, there is currently no way to apprehend the reasons of the decision making of the neural network, namely the variables that had the most influence on the decision making, which can give rise to a problem from a legal/regulatory standpoint.

There is therefore a need for a user to easily check the results provided by an artificial neural network in order to ensure that the latter does not take non-pertinent data into account, regardless of the type of data processed and therefore to have factual and objective technical elements to be able to analyse and understand a decision making by an artificial neural network.

### SUMMARY OF THE INVENTION

The invention provides a solution to the problems mentioned hereinabove, by making it possible to check the pertinence of the data used in the decision making by an artificial neural network.

A first aspect of the invention relates to a method of modelling for checking the results provided by an artificial neural network comprising the following steps implemented by a computer:
Generating an artificial neural network;
Training the artificial neural network on a training database;
Testing the artificial neural network on at least one test datum dependent on a plurality of variables vᵢ so as to obtain a result R per test datum, the result R being dependent on the variables vᵢ;
For each result R:
   Approximating by a linear model a first function F₁ dependent solely on the result R so as to obtain a second function F₂, the first function F₁ and the second function F₂ being dependent on the variables vᵢ;
   Simplifying the second function F₂ to obtain a third function F₃ dependent on a smaller number of variables vᵢ;
   Applying to the third function F₃ the inverse function of the first function F₁ to obtain an operating model of the neural network.

Thanks to the invention, an operating model of the neural network is generated for each datum tested, each operating model which depends on a reduced number of variables which are the variables that have the most weight in the decision making of the neural network. It is thus possible to check the results of the neural network in order to be able for example diagnose a training database, compare the performance of two neural networks or analyse the decision making by a neural network. The method of modelling thus defined is deterministic and reproducible, i.e. the operating model generated is the same as long as the same neural network, the same training database and the same test datum are retained. In addition to the characteristics that have just been mentioned in the preceding paragraph, the method of modelling according to a first aspect of the invention can have one or more additional characteristics among the following, taken individually or according to any technically permissible combinations.

Advantageously, the first function F₁ is a non-bounded function. Thus, the linear approximation of the first function F₁ is more pertinent given that a linear function is not bounded.

Advantageously, the first function F₁ is defined by:

$${F}_{1} = log \frac{R}{1 - R}$$

Thus, the result R can be obtained by applying to the function F₁ the sigmoid function that is used in logistic regression, one of the simplest algorithms used in automatic learning.

Advantageously, the second function F₂ is the linear approximation of the first function F₁ in the neighbourhood of a datum. Thus, it is sufficient to calculate the gradient of the first function F₁ with respect to the variables vᵢ in order to obtain the second function F₂.

Advantageously, the second function F₂ is expressed as the sum of a y-intercept point b and of the sum of the variables vᵢ each multiplied by a slope aᵢ:

$${F}_{2} = b + {\sum }_{i} {a}_{i} {v}_{i}$$

Thus, the second function F₂ is a linear approximation of the first function F₁ with respect to all the variables vᵢ on which the result depends. Advantageously, a first variable v₁ correlated with a second variable v₂ is expressed according to the second variable v₂ as the sum of an uncorrelated variable ε₁ and of a correlation coefficient C₁₂ multiplied by the second variable v₂:

v₁=C₁₂v₂+ε₁

Advantageously, the step of simplifying comprises the following sub-steps:
Creating a variable vector Vᵥ comprising the variables vᵢ;
Creating an empty synthetic variable vector Vᵥₛ;
Creating an empty contribution coefficient vector V_{c};
Carrying out at least one time the following sub-steps:
   For each variable vₖ of the variable vector Vᵥ, expressing a contribution coefficient Wₖ according to the slope aₖ of said variable vₖ, of the slopes as and of the correlation coefficients Cₖᵢ of the variables vᵢ of the variable vector Vᵥ correlated with said variable vₖ;
   Comparing the absolute values of the contribution coefficients Wᵢ, and determining a reference variable v_{ref} that has the contribution coefficient W_{ref} with the highest absolute value;
   Adding to the synthetic variable vector Vᵥₛ said reference variable V_{ref},
   Adding to the contribution coefficient vector V_{c} the contribution coefficient W_{ref} of said reference variable v_{ref},
   For each variable vₖ of the variable vector Vᵥ different from the reference variable v_{ref} and correlated with the reference variable v_{ref}, expressing said correlated variable vₖ according to the reference variable v_{ref} and normalising the uncorrelated variable εₖ so as to obtain a new variable vₖ′;
   Emptying the variable vector Vᵥ and filling the variable vector Vᵥ with the new variables vᵢ′;
Expressing the variables contained in the synthetic variable vector Vᵥₛ according to the variables vᵢ of the second function F₂ so as to obtain remaining variables vrₚ;
Expressing a remaining variable slope arₚ for each remaining variable vrₚ using the contribution coefficient vector V_{c}.

Thus, only the variables vᵢ having a substantial contribution coefficient are retained by taking the correlations between variables into account. Advantageously, the third function F₃ is expressed as the sum of the y-intercept point b and of the sum of the remaining variables vrₚ each one multiplied by its remaining variable slope arₚ:

$${F}_{3} = b + {\sum }_{p} a {r}_{p} v {r}_{p}$$

Thus, the third function F₃ depends on a smaller number of variables than the result which makes checking this result easier.

Advantageously, the method according to a first aspect of the invention comprises a step of summarising the operating models obtained. Thus, it is possible to check the coherency of the results of the neural network.

A second aspect of the invention relates to a method of checking the results provided by an artificial neural network characterised in that it comprises all the steps of the method of modelling according to a first aspect of the invention and an additional step of evaluating the training database using at least one operating model.

Thus, using the operating model obtained, it is possible to diagnose a training database that is not suited to the task that the user wants to carry out with the neural network.

A third aspect of the invention relates to a method of comparing the performance of a first artificial neural network and of a second artificial neural network, characterised in that it comprises the following steps:
Applying the method of modelling according to a first aspect of the invention to the first neural network so as to obtain at least one first operating model of the first artificial neural network;
Applying the method of modelling according to a first aspect of the invention to the second neural network so as to obtain at least one second operating model of the second artificial neural network;
Comparing the performance of the first artificial neural network and of the second artificial neural network by comparing each first operating model of the first artificial neural network and each second operating model of the second artificial neural network that correspond to the same test datum.

Thus, by comparing the first operating model and the second operating model that correspond to the same test datum, it is possible to compare the performance of a first neural network and of a second neural network in order to choose the neural network that takes into account the most pertinent variables of the tested datum.

A fourth aspect of the invention relates to a method of analysing a decision making by an artificial neural network, the decision having been taken based on at least one test datum, characterised in that it comprises the steps of the method of modelling according to any of claims 1 to 5 followed by a step of generating an explanatory report of the decision making using the operating model of the artificial neural network that corresponds to the test datum.

Thus, thanks to the operating model of the neural network, it is possible to objectively understand the reasons for the decision making of a neural network by identifying the variables that have the most weight in this decision making.

A fifth aspect of the invention relates to a computer characterised in that it is suitable for implementing the method of modelling according to a first aspect of the invention and/or the method of checking according to a second aspect of the invention and/or the method of comparing according to a third aspect of the invention.

A sixth aspect of the invention relates to a computer program product comprising instructions that, when the program is executed by a computer, lead the latter to implement the steps of the method of modelling according to a first aspect of the invention and/or of the method of checking according to a second aspect of the invention and/or of the method of comparing according to a third aspect of the invention.

A seventh aspect of the invention relates to a recording medium that can be read by a computer, on which the computer program product according to a fifth aspect of the invention is recorded.

The invention and its various applications shall be better understood when reading the following description and examining the accompany figures.

### BRIEF DESCRIPTION OF THE FIGURES

The figures are presented for the purposes of information and in no way limit the invention.

FIG. 1 shows a block diagram of the method of modelling according to a first aspect of the invention.

FIG. 2 shows a block diagram of the method of checking according to a second aspect of the invention.

FIG. 3 shows a block diagram of the method of comparing according to a third aspect of the invention.

FIG. 4 shows a block diagram of the method of analysing according to a fourth aspect of the invention.

### DETAILED DESCRIPTION OF AT LEAST ONE EMBODIMENT OF THE INVENTION

Unless mentioned otherwise, the same element appearing in different figures has a unique reference.

A first aspect of the invention relates to a method of modelling 100 for checking the results provided by an artificial neural network.

In the remainder of the application, the terms “neuron” and “artificial neuron” shall be used indifferently.

A neural network comprises a plurality of layers each comprising a plurality of neurons. For example, a neural network comprises between 2 and 20 layers and each layer of the neural network comprises between 10 and 2000 neurons. Generally, each neuron of each layer is connected to each neuron of the preceding layer and to each neuron of the following layer via an artificial synapse. However, it could be considered the case where each neuron of each layer is connected solely to a portion of the neurons of the preceding layer and/or to a portion of the neurons of the following layer. A connection between two neurons is allocated a weight or synaptic coefficient and each neuron is allocated a bias coefficient. The bias coefficient of a neuron is its default value, i.e. its value when the neurons of the preceding layer to which it is connected are not sending it any signal. The objective of the method of modelling 100 is to generate a simplified model for each result R generated by the neural network. “Result generated by a neural network” means an output datum associated with the decision making by the neural network concerning an input datum. Before being able to generate results, the neural network is trained on a training database or learning database in order to be adapted to a predefined task. The learning can be supervised or non-supervised. With supervised learning, the learning is restricted by the learning database. Indeed, the learning database is annotated to signal to the neural network the structures that it must detect. On the contrary, with non-supervised learning, the neural network itself finds the underlying structures using the raw data in the training database.

The predefined task is for example detection, classification or recognition. Classifying data consists of separating it into several classes, i.e. in classing it, and in identifying each one of the classes. For example, in a sample that contains black data and white data, classing the data corresponds to separating it into two classes while classifying the data corresponds to separating it into classes and assigning the name “black class” to one and “white class” to the other. Thus, a neural network that has received supervised learning is able to classify data while a neural network that has received non-supervised learning is only able to class data. The neural network is then tested on a test database or generalisation database. For each test datum of the test database, the neural network then supplies a result R illustrating its decision making concerning the test datum. For example, if the task for which the neural network was trained is classification and the neural network took the decision that the test datum was part of the class C, the result R provided by the neural network is the probability associated with the class C.

In practice, the training database and the test database can be two separate databases or two separated portions of the same database. The data used in the training database and in the test database is for example biological data, data concerning the carrying out of a method or of a product, images, audio data or electrical signals. A datum comprises a plurality of variables vᵢ and each datum used comprises the same number of variables vᵢ. For example, a datum comprises between 10 and 10,000 variables vᵢ.

The variables vᵢ can be of the numerical, binary, categorical type such as a nationality or a profession or dates. In the case of biological data, the variables vᵢ are for example information on a patient such as their age, their symptoms and their weight as well as information on the result of the tests that they have taken such as blood tests or MRI scans. In the case of data concerning the carrying out of a product, the variables vᵢ are for example information on the product such as its name, and its composition as well as information on its method of manufacture such as its manufacturing time, the name of the assembly line on which it was produced. In the case of data concerning images, the variables vᵢ are for example the variance and the average of the grey levels.

The data used can be tabular data comprising a plurality of examples, each example depending on a plurality of variables vᵢ. A datum used of the tabular type comprises for example between 1,000 and 1,000,000 examples, each comprising between 10 and 10,000 variables vᵢ.

Consider the example of a neural network comprising L layers of N neurons, used on a test datum that depends on N variables vᵢ.

The expression hₖ^{(I+1)} of the neuron k of the layer I+1 is expressed according to the N neurons i of the layer I in the following way:

$${h}_{k}^{( l + 1 )} = f ( {\sum }_{i = 1}^{N} {P}_{k i}^{( l + 1 )} {h}_{i}^{( l )} + {b}_{k}^{( l + 1 )} )$$

With f a non-linear function, Pₖᵢ^{(I+1)} the weight allocated to the connection between the neuron k of the layer I+1 and the neuron i of the layer I, hᵢ^{(I)} the expression of the neuron i of the layer I and bₖ^{(I+1)} the bias coefficient allocated to the neuron k of the layer I+1.

The function f is defined for example as: f(z)=max(z,0)

The expression of the neuron k of a layer is therefore expressed according to the expressions of the neurons of the preceding layer and the expression hₖ⁽¹⁾ of the neuron k of the layer 1 is expressed according to variables vᵢ of the input datum in the following way:

$${h}_{k}^{( 1 )} = f ( {\sum }_{k = 1}^{n} {P}_{k i}^{( 1 )} {v}_{i} + {b}_{k}^{( 1 )} )$$

For a classification problem, the probability pₖ associated with the class k is then expressed in the following way:

$${p}_{k} = \frac{{e}^{{c}_{k}}}{{\sum }_{j = 1}^{N} {e}^{{c}_{j}}} with {c}_{k} = {\sum }_{j = 1}^{N} {P}_{k j}^{( L )} {h}_{j}^{( L - 1 )} + {b}_{k}^{( L )}$$

The result R then corresponds to the maximum probability pₖ.

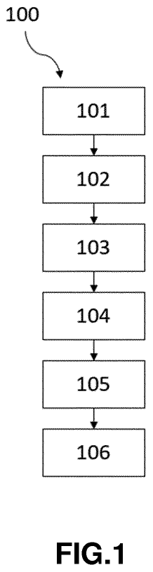

The result R generated by a neural network is therefore a function of all the variables vᵢ of the test datum for which the result R is generated, parametrized by the synaptic coefficients Pₖᵢ allocated to the connections of the neural network and by the bias coefficients bₖ allocated to each neuron. It therefore quickly becomes very complicated to check the results provided by a neural network, as the number of variables vᵢ of test data can range up to 10,000. The method of modelling 100 provides a model that is an approximation of the result R generated by a neural network by a simplified expression, which is according to a more restricted number of variables vᵢ. The method of modelling 100 according to a first aspect of the invention comprises several steps of which the sequence is shown in FIG. 1. These steps are implemented by a computer comprising at least one processor and one memory.

The first step 101 of the method of modelling 100 is a step of generating an artificial neural network. For this, the number of layers and the number of neurons per layer of the neural network are fixed as well as other parameters such as the learning pitch and the regularisation coefficient, which describe its learning process. The learning pitch of the neural network defines the frequency at which the weights of the neural network are updated during the learning phase and the regularisation coefficient limits over-learning of the neural network.

At the end of this step 101 of generating of the neural network, the neural network is ready to be trained.

The second step 102 of the method of modelling 100 is a step of training of the neural network on a training database. At the end of this step 102 of training of the neural network, the neural network is able to perform a predefined task on a certain type of data, the type of data present in the training database.

The third step 103 of the method of modelling 100 is a step of testing the neural network on at least one test datum that depends on a plurality of variables vᵢ. The test data is of the same type as the data of the training database. During this step, the neural network generates a result R per test datum processed, the result R dependent on the same variables vᵢ as the test datum processed.

The fourth step 104 of the method of modelling 100 is a step of linear approximation of a first function F₁ dependent on a result R generated in the preceding step 103.

A result R is a function of the variables vᵢ a function of which the values are comprised between 0 and 1. The result R is therefore a bounded function.

However, a linear function is not bounded. A transformation is therefore advantageously applied to the result R so as to obtain a first non-bounded function F₁ that will be approximated linearly.

The first function F₁ is for example defined by:

$${F}_{1} = log \frac{R}{1 - R}$$

Thus, the first function F₁ is not bounded and depends on the same variables vᵢ as the result R.

The first function F₁ is thus obtained by applying to the result R the inverse function of the sigmoid function σ which is defined as:

$$σ ( z ) = \frac{1}{1 + {e}^{- z}}$$

The sigmoid function is used in logistic regression, one of the simplest automatic learning algorithms that makes it possible to separate one class from all the other classes of the problem. Indeed, logistic regression consists of applying a sigmoid function to a linear expression. Thus, approximating the function F₁ by a linear function L amounts to approximating the result R by a logistic regression σ(L).

The first function F₁ is then approximated linearly, for example in the neighbourhood of the test datum, so as to obtain a second function F₂. The second function F₂ is then expressed in the following way:

$${F}_{2} = b + {\sum }_{i} {a}_{i} {v}_{i}$$

With: b a y-intercept point, as a slope and vᵢ the variables of the test datum. If the linear approximation is carried out in the neighbourhood of the test datum, there is:

$$b = {F}_{1} ( X ) - {\sum }_{i = 1}^{N} \frac{\partial {F}_{1}}{\partial {v}_{i}} ( X ) {X}_{i}$$

$${a}_{i} = \frac{\partial {F}_{1}}{\partial {v}_{i}} ( X )$$

With: X, the neighbouring data point of the test datum considered. It is then sufficient to calculate the gradients of the first function F₁ with respect to the variables vᵢ of the test datum to obtain the second function F₂. The fifth step 105 of the method of modelling 100 according to a first aspect of the invention is a step of simplifying the second function F₂.

The step 105 of simplifying comprises a first phase consisting of classing the variables vᵢ by eliminating the correlations between the variables vᵢ. Initially, the variables vᵢ are normalised. For example, all the variables vᵢ have a zero average and a standard deviation of 1.

A contribution coefficient Wᵢ is calculated for each variable vᵢ of the test datum. The contribution coefficient Wₖ of the variable k is expressed in the following way:

$${W}_{k} = {a}_{k} + {{\sum }^{k - 1}}_{j = 1} {C}_{k j} {a}_{j} + {{\sum }_{j = k + 1}}^{N} {C}_{k i} {a}_{j}$$

With aₖ the slope of the variable k in the second function F₂, aⱼ the slope of the variable j in the second function F₂ and Ckⱼ the correlation coefficient between the variable k and the variable j.

The variable vᵢ with the contribution coefficient W that has the highest absolute value is designated as reference variable v_{ref}. Each variable vᵢ different from the reference variable v_{ref} is then expressed as a function of the reference value v_{ref} in the following way:

Vᵢ=C_{iref}V_{ref}+εᵢ

With εᵢ a variable not correlated with the variable v_{ref} and C_{iref} the correlation coefficient between the variable i and the reference variable v_{ref}. εᵢ is then normalised so as to obtain a new variable vᵢ′:

$${v}_{i}^{′} = \frac{{ɛ}_{i}}{\sqrt{1 - {C}_{i r e {f}^{2}}}}$$

The new variables vᵢ′ thus obtained are comparable because they are of the same average and of the same standard deviation.

The slope aᵢ′ of each variable vᵢ′ is then expressed in the following way:

a′ᵢ=\sqrt{1−C_{iref}²aᵢ}

The same steps are then applied to the new variables vᵢ′, i.e. a contribution coefficient Wᵢ′ that depends on the slopes aᵢ′ and correlation coefficients between the new variables Cᵢⱼ′ is calculated for each new variable vᵢ′, a new reference value v_{ref}′ is selected and new variables vᵢ″ are obtained and so on over several iterations.

The number of iterations is predefined. The number of iterations is strictly less than the number of variables vᵢ of the second function F₂ and greater than or equal to 1. The pertinence of the value chosen for the number of iterations can be checked by comparing the linear function obtained for this number of iterations and the linear function obtained for a higher number of iterations, using a measurement of proximity, for example the ratio of the norms of the slope vectors of the linear functions obtained.

The reference value obtained at each iteration is a synthetic variable, the synthetic variables being independent from each other.

Thus, if p iterations are carried out, p synthetic variables are obtained and at the end of these p iterations, the contribution coefficients of all the other variables are set to zero.

For example, if the second function F₂ depends on 5 variables vᵢ, v₂, v₃, v₄ and v₅, and the number of iterations chosen is three, the first phase of the step 105 of simplifying consists, in a first step, of calculating the correlation coefficient of each variable W₁, W₂, W₃, W₄ and W₅. For example, W₃ is:

W₃=a₃+C₃₁a₁+C₃₂a₂+C₃₄a₄+C₃₅a₅

The absolute values of the correlation coefficients W₁, W₂, W₃, W₄ and W₅ are compared with each other and the variable that has the correlation coefficient with the highest absolute value is selected as the reference value. For example, vᵢ is selected as the reference value.

The remaining variables v₂, v₃, v₄ and v₅ are then expressed as a function of the reference variable vᵢ. For example, v₂ is:

V₂=C₂₁v₁+ε₂

Using these expressions, new variables v₂′, v₃′, v₄′ and v₅′ are calculated. For example, v₂′ is:

$${v}_{2}^{′} = \frac{{ɛ}_{2}}{\sqrt{1 - {C}_{21}^{2}}}$$

At the end of these calculations, the first iteration is ended and the same steps as hereinabove are applied to the new variables v₂′, v₃′, v₄′ and v₅′. For example, v₂″ is selected as the reference variable. v₃′, v₄′ and v₅′ are then expressed as a function of v₂′. For example, v₃′ is:

V₃′=C′₃₂V₂′ε₃

Then, new variables v₃″, v₄″ and v₅″ are calculated. For example, v₃″ is:

$${v}_{3}^{″} = \frac{{ɛ}_{3}^{′}}{\sqrt{1 - {{C}_{32}^{′}}^{2}}}$$

At the end of these calculations, the second iteration is ended. During the third and last iteration, a reference variable is selected from the new variables v₃″, v₄″ and v₅″ as hereinabove. For example, v₃″ is selected as the reference variable. Then, the contribution coefficients of the remaining variables v₄″ and v₅″ are set to zero.

At the end of the first phase of the step 105 of simplifying, three synthetic variables vᵢ, v₂″ and v₃″ are obtained.

The synthetic variables thus expressed do not correspond to the variables vᵢ of the test datum. To be able to check the result R of the neural network, it would be necessary for the result R to depends on variables vᵢ of the test datum.

In a second phase of the step 105 of simplifying, the synthetic variables are therefore expressed as a function of the variables vᵢ of the test datum by using the following formula until their expression depends only on variables vᵢ of the second function F₂:

$${v}_{j}^{( l )} = \frac{{v}_{j}^{( l - 1 )} - {C}_{ij}^{( l - 1 )} {v}_{i}^{( l - 1 )}}{\sqrt{1 - {C}_{ij}^{( l - 1 ) 2}}}$$

With vⱼ^{(I)}, the variable j at iteration I+1, vⱼ^{(I-1)} the variable j at iteration I, vᵢ^{(I-1)} the reference variable at iteration I initially corresponding to the variable i and Cᵢⱼ^{(I-1)} the correlation coefficient between the variable i and the variable j at iteration I.

Taking the preceding example of the second function F₂ dependent on 5 variables, the reference value of the first iteration is the variable v₁ and the reference value of the second iteration is the variable v₂′, therefore the reference value of the second iteration is expressed as:

$${v}_{2}^{′} = \frac{{v}_{2} - {C}_{12} {v}_{1}}{\sqrt{1 - {C}_{12}^{2}}}$$

The reference value of the third iteration is the variable v₃″, that is therefore expressed as:

$${v}_{3}^{″} = \frac{{v}_{3}^{′} - {C}_{23}^{′} {v}_{2}^{′}}{\sqrt{1 - {{C}_{23}^{′}}^{2}}}$$

With

$${v}_{3}^{′} = \frac{{v}_{3} - {C}_{13} {v}_{1}}{\sqrt{1 - {C}_{13}^{2}}}$$

The variables vᵢ of the test datum on which the synthetic variables depend are remaining variables vrₚ. The number of remaining variables vrₚ is strictly less than the number of variables vᵢ of the test datum.

The third function F₃ is then expressed as such:

$${F}_{3} = b + {\sum }_{p} a {r}_{p} v {r}_{p}$$

With arₚ a remaining variable slope.

To calculate the remaining variable slopes arₚ, the synthetic variables are passed through in reverse order from the last selected to the first selected. Thus, if there are p iterations, at step p−k+1 of calculating remaining variable slopes, the slope of the k-th synthetic variable selected at the k-th iteration of the first phase of the step 105 of simplifying is updated according to:

$${a}_{k}^{( p - k + 1 )} = {a}_{k}^{( p - k + 2 )} - {\sum }_{j = k + 1}^{p} \frac{{C}_{k j}^{( p - k + 2 )}}{\sqrt{1 - {C}_{k j}^{{( p - k + 2 )}_{2}}}} {a}_{j}^{( p - k + 2 )}$$

while the slopes of the variables selected after the k-th synthetic variable, i.e. the synthetic variables selected after the k-th iteration, are updated according to:

$${a}_{j}^{( p - k + 1 )} = \frac{1}{\sqrt{1 - {C}_{k j}^{{( p - k + 2 )}_{2}}}} {a}_{j}^{( p - k + 2 )}$$

Taking the preceding example of the second function F₂ dependent on 5 variables, the synthetic variables are vᵢ, v₂′ and v₃″.

At the step 1 of calculating remaining variable slopes, the slope of the third synthetic variable v₃″ is updated according to:

a₃′=a₃″

The other synthetic variables that were selected before the third synthetic variable, their slopes are not updated in this step.

At the step 2 of calculating remaining variable slopes, the slope of the second synthetic variable v₂′ is updated according to:

$${a}_{2} = {a}_{2}^{′} - \frac{{C}_{23}^{′}}{\sqrt{1 - {{C}_{23}^{′}}^{2}}} {a}_{3}^{′}$$

The slope of the third synthetic variable v₃″ selected after the second synthetic variable v₂′ is updated according to:

$${a}_{3} = \frac{1}{\sqrt{1 - {{C}_{23}^{′}}^{2}}} {a}_{3}^{′}$$

At the step 3 of calculating remaining variable slopes, the slope of the first synthetic variable v₁ is updated according to:

$$a {r}_{1} = {a}_{1} - \frac{{C}_{12}}{\sqrt{1 - {C}_{12}^{2}}} {a}_{2} - \frac{{C}_{13}}{\sqrt{1 - {C}_{13}^{2}}} {a}_{3}$$

The slopes of the second and third synthetic variable v₂′ and v₃″ selected after the first synthetic variable v₁ are updated according to:

$$a {r}_{2} = \frac{1}{\sqrt{1 - {C}_{12}^{2}}} {a}_{2} \\ a {r}_{3} = \frac{1}{\sqrt{1 - {C}_{13}^{2}}} {a}_{3}$$

At the end of the step 105 of simplifying, the third function F₃ therefore depends solely on the remaining variables vrₚ, i.e. of a reduced number of variables vᵢ of the test datum.

The step 106 of the method of modelling 100 according to a first aspect of the invention consists of applying the inverse function of the first function F₁ to the third function F₃ to obtain an operating model of the neural network for the result R. The operating model of the neural network is a simplified result R, which depends on a reduced number of variables vᵢ facilitating the checking of the result R provided by the neural network.

The method of modelling 100 according to a first aspect of the invention generates an operating model for each result R. If several results R have been generated by the neural network, the method of modelling 100 can for example comprise an additional step of summarising operating models. As the test data is similar, the step of summarising can make it possible to check the coherency of the results of the neural network.

A second aspect of the invention relates to a method of checking 200 to check the results provided by an artificial neural network.

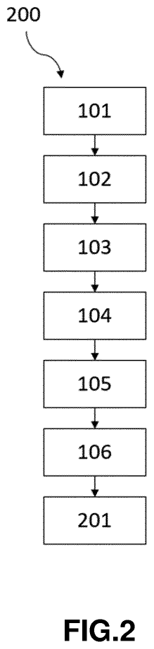

The method of checking 200 according to a second aspect of the invention comprises several steps of which the sequence is shown in FIG. 2.

The method of checking 200 according to a second aspect of the invention comprises all the steps 101 to 106 of the method of modelling 100 according to a first aspect of the invention making it possible to obtain at least one operating model of the neural network.

The method of checking 200 according to a second aspect of the invention then comprises a step 201 of evaluating the training database consisting of comparing the reduced number of variables vᵢ of which each operating model depends with a certain number of pertinent variables vᵢ.

For example, in the case of detecting people in an image, only the pixels of the image on which the people are located are pertinent. If the variables vᵢ are for example the average and the variance of each pixel of the image, the pertinent variables vᵢ are therefore the average and the variance of the pixels on which the people are located. If the operating model depends mostly on variables vᵢ linked to pixels that do not correspond to a person in the image but to pixels of the background, this means that the variables vᵢ taken into account in the decision making of the neural network are incorrect, and therefore that the learning did not make it possible for the neural network to become effective for the intended task. This is an indication that the training database is not suited for the detection of people. The non-pertinent variables vᵢ taken into account by the neural network then give paths that make it possible to understand why the training database is not suitable and thus to correct it. In this example, the fact that the neural network takes the pixels of the background into account can be due to an excessive homogeneity of the backgrounds behind the people. A solution is therefore to add to the training database images with more varied backgrounds.

On the contrary, if the operating model depends mostly on pertinent variables vᵢ, this means that the training database is well suited for the intended task.

A third aspect of the invention relates to a method of comparing 300 to compare the performance of two artificial neural networks. The two neural networks can, for a given test datum, have similar results, for example, in the case where it is sought to predict the illness of a patient using symptoms, the two neural networks give as output the same illness with the same certainty probability, or different results, for example, the two neural networks do not give the same illness as output. For two neural networks that have similar performance, this can then make it possible to choose a preferred neural network, that uses more pertinent variables in its decision making. For two neural networks that have different performance, this can for example make it possible to understand why one of the neural networks is defective.

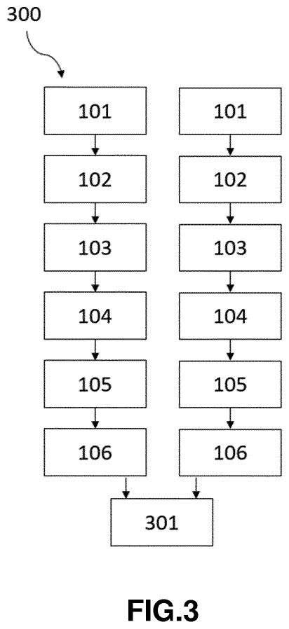

The method of comparing 300 according to a third aspect of the invention comprises several steps of which the sequence is shown in FIG. 3.

The method of comparing 300 according to a third aspect of the invention comprises all the steps 101 to 106 of the method of modelling 100 according to a first aspect of the invention for a first neural network making it possible to obtain at least one first operating model of the first neural network and all the steps 101 to 106 of the method of modelling 100 according to a first aspect of the invention for a second neural network making it possible to obtain at least one second operating model of the second neural network.

The method of comparing 300 according to a third aspect of the invention then comprises a step 301 of comparing performance of the first neural network and of the second neural network by comparing for the same test datum, the first operating model of the first artificial neural network and the second operating model of the second artificial neural network. More precisely, the step 301 of comparing consists of comparing the variables vᵢ that the first operating model depends on and the variables vᵢ that the second operating model depends on. The variables vᵢ taken into account in one of the two operating models and not in the other operating model are then compared with a certain number of pertinent variables vᵢ. Thus, the neural network that uses the least number of non-pertinent variables vᵢ in its decision making is considered as performing better.

For example, in the case where it is sought to predict the illness of a patient using their symptoms, the first operating model takes fever, fatigue and muscle soreness into account while the second operating model takes fever, fatigue and ear pain into account in order to diagnose influenza. The variables vᵢ taken into account in one of the two operating models and not in the other operating model are the muscle soreness for the first operating model and the ear pain for the second operating model. The pertinent variables vᵢ are the symptoms that are commonly observed in a patient afflicted with influenza. The muscle soreness is therefore part of the pertinent variables vᵢ which is not the case with ear pain. The neural network that performs better in carrying out this task is therefore the first neural network.

The method of checking 200 and the method of comparing 300 are compatible, i.e. the method of comparing 300 can comprise the step 201 of evaluating the training database.

The step 201 of evaluating the training database of the method of checking 200 and the step 301 of comparing performance of the two neural networks can be implemented by a computer or carried out manually.

A fourth aspect of the invention relates to a method of analysing the decision making by an artificial neural network.

The decision making is automatic, i.e. it is carried out by a neural network that has been trained for this decision making.

The decision is taken using at least one test datum.

For example in the context of an autonomous vehicle, the decision making of a neural network suitable for detecting pedestrians can be to brake or not brake according to whether or not a pedestrian is present in the close environment of the car.

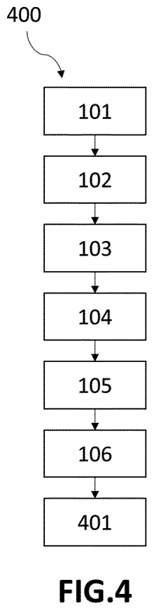

The method of analysing 400 according to a fourth aspect of the invention comprises several steps of which the sequence is shown in FIG. 4. The method of analysing 400 according to a fourth aspect of the invention comprises all the steps 101 to 106 of the method of modelling 100 according to a first aspect of the invention for a neural network making it possible to obtain at least one operating model of the neural network using at least one test datum.

The method of analysing 400 according to a fourth aspect of the invention then comprises a step 401 of generating a report that explains the decision making of the neural network using the operating model or models that correspond to the test datum or data.

The step 401 of generating a report consists for example of summarising the operating models if there are several of them in order to identify the variables that have the most weight in the decision making and generating a report that comprises these variables.

The summary consists for example in retaining only the variables that have a percentage of presence in the operating models greater than a certain presence threshold.

The report comprises for example the variables along with their percentage of presence and their weight in the decision making.

Thus, in the case of a neural network suitable for diagnosing an illness based on symptoms, the main symptoms that resulted in the diagnosis of such an illness are indicated in the report generated. It is then possible to identify any possible defects of the neural network and to correct them. In case of serious fault linked to the decision making of a neural network, for example incorrect medication linked to an incorrect diagnosis that resulted in complications or an accident involving an autonomous vehicle, such a report makes it possible to determine the causes of the fault and possibly the person or people who are responsible, thus responding to a legal/regulatory imperative.

1. Method of modelling for checking the results provided by an artificial neural network comprising the following steps implemented by a computer:
generating an artificial neural network;
training the artificial neural network on a training database;
testing the artificial neural network on at least one test datum dependent on a plurality of variables vᵢ so as to obtain a result R per test datum, the result R being dependent on the variables vᵢ;
for each result R:
approximating by a linear model a first function F₁ dependent solely on the result R so as to obtain a second function F₂, the first function F₁ and the second function F₂ being dependent on the variables vᵢ;
simplifying the second function F₂ to obtain a third function F₃ dependent on a smaller number of variables vᵢ;
applying to the third function F₃ the inverse function of the first function F₁ to obtain an operating model of the neural network.

2. The method of modelling according to claim 1, wherein the second function F₂ is expressed as the sum of a y-intercept point b and of the sum of the variables vᵢ each multiplied by a slope
$${F}_{2} = b + {\sum }_{i} {a}_{i} {v}_{i}$$

3. The method of modelling according to claim 1, wherein a first variable v₁ correlated with a second variable v₂ is expressed according to the second variable v₂ as the sum of an uncorrelated variable ε₁ and of a correlation coefficient C₁₂ multiplied by the second variable v₂:
v₁=C₁₂v₂+ε₁

4. The method of modelling according to claim 2, wherein a first variable v₁ correlated with a second variable v₂ is expressed according to the second variable v₂ as the sum of an uncorrelated variable ε₁ and of a correlation coefficient C₁₂ multiplied by the second variable v₂:
v₁=C₁₂v₂+ε₁
and wherein the step of simplifying comprises the following sub-steps:
creating a variable vector Vᵥ comprising the variables vᵢ;
creating an empty synthetic variable vector Vᵥₛ;
creating an empty contribution coefficient vector V_{c};
carrying out at least one time the following sub-steps:
for each variable vₖ of the variable vector Vᵥ, expressing a contribution coefficient Wₖ according to the slope aₖ of said variable vₖ, of the slopes aᵢ and of the correlation coefficients Cₖᵢ of the variables vᵢ of the variable vector Vᵥ correlated with said variable vₖ;
comparing the absolute values of the contribution coefficients Wᵢ and determining a reference variable v_{ref} that has the contribution coefficient W_{ref} with the highest absolute value;
adding to the synthetic variable vector Vᵥₛ said reference variable v_{ref};
adding to the contribution coefficient vector V_{c} the contribution coefficient W_{ref} of said reference variable v_{ref};
for each variable vₖ of the variable vector Vᵥ different from the reference variable v_{ref} and correlated with the reference variable v_{ref}, expressing said correlated variable vₖ according to the reference variable v_{ref} and normalising the uncorrelated variable εₖ so as to obtain a new variable vₖ′;
emptying the variable vector Vᵥ and fill the variable vector Vᵥ with the new variables vᵢ′;
expressing the variables contained in the synthetic variable vector Vᵥₛ according to the variables vᵢ of the second function F₂ so as to obtain remaining variables vrₚ;
expressing a remaining variable slope arₚ for each remaining variable vrₚ using the contribution coefficient vector V_{c}.

5. The method of modelling according to claim 4, wherein the third function F₃ is expressed as the sum of the y-intercept point b and of the sum of the remaining variables vrₚ each one multiplied by its remaining variable slope arₚ:
$${F}_{3} = b + {\sum }_{p} a {r}_{p} v {r}_{p}$$

6. Method of checking the results provided by an artificial neural network comprising all the steps of the method of modelling according to claim 1 and an additional step of evaluating the training database using at least one operating model.

7. Method of comparing the performances of a first artificial neural network and of a second artificial neural network, comprising:
applying the method of modelling according to claim 1 to the first artificial neural network so as to obtain at least one first operating model of the first artificial neural network;
applying the method of modelling according to claim 1 to the second artificial neural network so as to obtain at least one second operating model of the second artificial neural network;
comparing the performance of the first artificial neural network and of the second artificial neural network by comparing each first operating model of the first artificial neural network and each second operating model of the second artificial neural network that correspond to the same test datum.

8. A computer adapted to implement the method of modelling according to claim 1.

9. A computer program product comprising instructions that, when the program is executed by a computer, lead the latter to implement the steps of the method of modelling according to claim 1.

10. A non-transitory recording medium that is readable by a computer, on which the computer program product is recorded according to claim 9.

11. Method of analysing a decision making by an artificial neural network, the decision having been taken based on at least one test datum, the method comprising the steps of the method of modelling according to claim 1 followed by a step of generating an explanatory report of the decision making using the operating model of the artificial neural network that corresponds to the test datum.
